(19) United States
(12) Patent Application Publication
(10) Pub. No.: US 2004/0198444 A1
(43) Pub. Date: Oct. 7, 2004

(54) Mobile phone IC card holder

(76) Inventor: Yen-Hung Chen, Junghe City (TW)

Correspondence Address: JACOBSON HOLMAN PLLC, 400 SEVENTH STREET N.W., SUITE 600, WASHINGTON, DC, 20004, US

(21) Appl. No.: 10/209,945

(22) Filed: Aug. 2, 2002

(51) Int. Cl. H04B 1/38

(52) U.S. Cl. 455/558; 455/90.1

(57) ABSTRACT

A mobile phone IC card holder includes an IC card holder disposed on a circuit board of a mobile phone, and a plurality numbers of elastic connectors are on the IC card holder. The IC card can be inserted into the IC card holder, the elastic connector of the IC card holder can connect the connectors of the IC card firmly. The IC card holder is in frame structure with a parallel insertion slot, the elastic connectors are inside the parallel insertion slot. When the IC card is inserted into the parallel insertion slot of the IC card holder, the IC card can be pressed firmly by the elastic connector of the IC card holder to avoid the bad connection condition of the IC card and the IC card holder.

### BACKGROUND OF THE INVENTION

I. Field of the Invention

This invention relates generally to a mobile phone IC card holder and, more specifically, to a mobile phone IC card holder that can hold and press the IC card firmly inside the IC card holder to avoid the bad connection situation.

II. Description of the Prior Art

Heretofore, it is known that a mobile phone needs an IC card that equipped with a phone number to be served; the insertion mechanism of the known mobile phones, as shown in FIG. 4, is to have a circuit board (b) inside the body (a) of the mobile phone, an IC card holder (c) is on the circuit board (b); a plurality numbers of elastic connector (c1) are on the IC card holder (c) to have the connectors (not shown in FIG) of the IC card (d) attach firmly on the elastic connector (c1) of the IC card holder (c) after the IC card (d) is inserted; in order to make sure that the IC card (d) is pressed on the elastic connector (c1), two shoulder grip plate (a1) are installed on the body (a), the shoulder grip plate (a1) can press the IC card (d) firmly onto the elastic connector (c1).

The IC card (d) is pressed onto the elastic connector (c1) of the IC card holder (c) by the shoulder grip plate (a1) of the body (a), however the shoulder grip plate (a1) and the IC card holder (c) of the circuit board (b) are two independent structures, they are not a solid body, therefore the combination is not so strong. If the mobile pone is impacted externally, the shoulder grip plate (a1) of the body (a) might not be able to hold the IC card (d) firmly onto the elastic connector (c1) of the IC card holder (c) that introduces bad connection.

### SUMMARY OF THE INVENTION

It is therefore a primary object of the invention to provide a mobile phone IC card holder to hold and press the IC card firmly inside the mobile phone to avoid the bad connection condition from happening.

In order to achieve the objective set forth, a mobile phone IC card holder in accordance with the present invention comprises a circuit board of the mobile phone with an IC card holder, a plurality numbers of elastic connectors are on the IC card holder, the IC card can be inserted into the IC card holder, the elastic connector of the IC card holder can connect the connectors of the IC card firmly. The IC card holder is in frame structure with a parallel insertion slot, the elastic connectors are inside the parallel insertion slot. When the IC card is inserted into the parallel insertion slot of the IC card holder, the IC card can be pressed firmly by the elastic connector of the IC card holder to avoid the bad connection condition of the IC card and the IC card holder.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a cross-sectional view of the present invention;

FIG. 3 is a perspective view of the present invention being assembled with an IC card;

FIG. 4 is a cross-sectional view of the prior art.

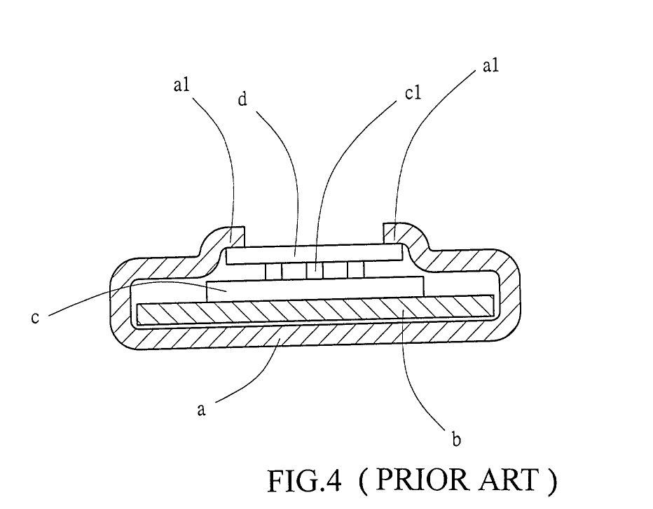

### DESCRIPTION OF THE PREFERRED EMBODIMENT

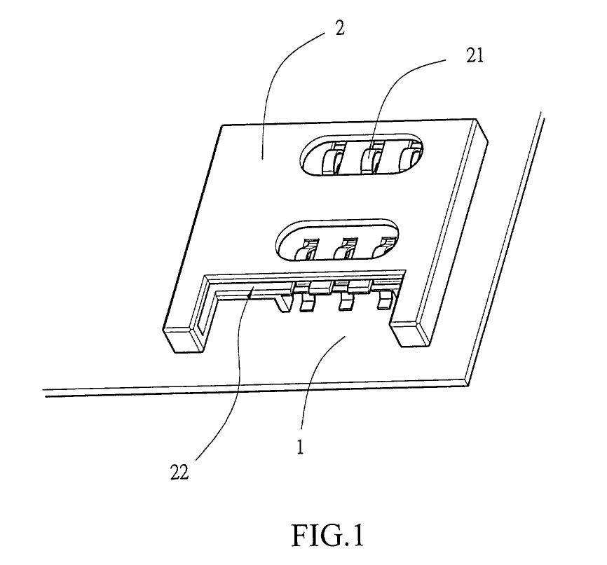

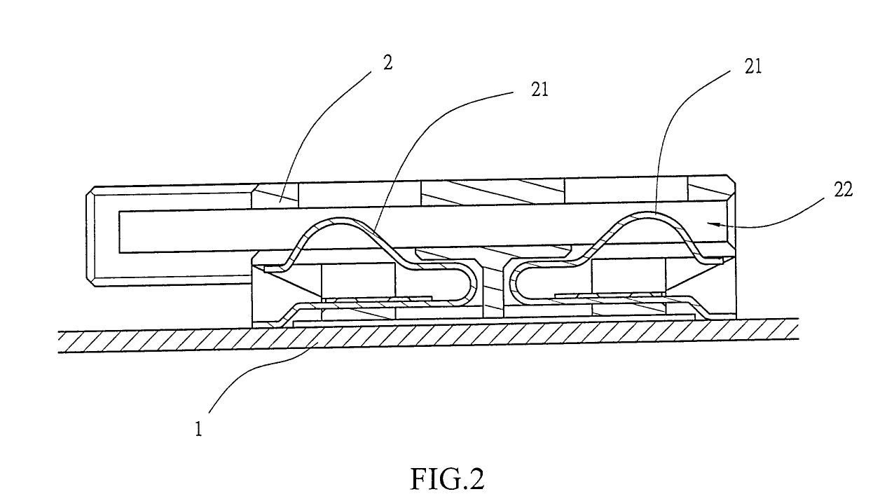

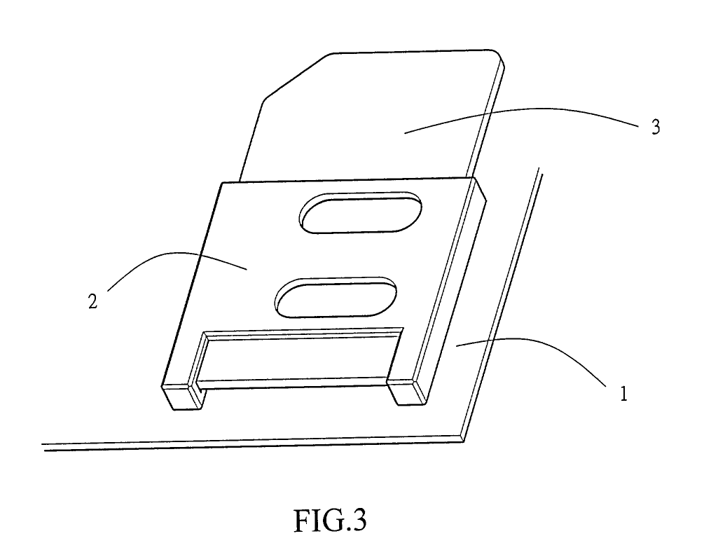

Referring to FIG. 1 and FIG. 2, the present invention is composed of an IC card holder (2) disposed on a circuit board (1) of the mobile phone, a plurality numbers of elastic connector (21) are on the IC card holder (2), the IC card (3) of the mobile phone can be inserted into the IC card holder (2), as shown in FIG. 3, the elastic connector (21) of the IC card holder (2) can connect the connectors (not shown in FIG) of the IC card (3) firmly. The functions of each component are described below:

The IC card holder (2) is in frame structure with a parallel insertion slot (22), the elastic connector (21) are inside the parallel insertion slot (22).

Based on structure described above, the IC card holder (2) of the mobile phone to hold the IC card (3) is in frame structure, when the IC card (3) of the mobile phone is inserted into the parallel insertion slot (22) of the IC card holder (2), the IC card (3) can be pressed firmly by the elastic connector (21) of the IC card holder (2) to avoid the bad connection condition of the IC card (3) and the IC card holder (2).

The IC card holder (2) is in frame structure and the IC card (3) is firmly pressed on the elastic connector (21) to form a strong body with stronger structure, upon strong external impact; the IC card (3) can be protected by the IC card holder (2) with frame structure to avoid the bad connection condition.

While a preferred embodiment of the invention has been shown and described in detail, it will be readily understood and appreciated that numerous omissions, changes and additions may be made without departing from the spirit and scope of the invention.

What is claimed is:

1. A mobile phone IC card holder comprising:
an IC card holder disposed on a circuit board of a mobile phone;
a plurality numbers of elastic connectors located on said IC card holder for connecting connectors of said IC card firmly;
wherein said IC card holder is in frame structure with a parallel insertion slot thereof, said elastic connectors are installed inside said parallel insertion slot; thus when an IC card is inserted into said parallel insertion slot of said IC card holder, said IC card can be pressed firmly by said elastic connector of said IC card holder.
